(19) United States
(12) Patent Application Publication
(10) Pub. No.: US 2015/0016919 A1
(43) Pub. Date: Jan. 15, 2015

(54) Fastener For Fitness Apparatus

(71) Applicant: Dynamic Fitness & Strength, LLC, Eau Claire, WI (US)

(72) Inventors: Jason Tambornino, Chippewa Falls, WI (US); Curt Tambornino, Altoona, WI (US)

(21) Appl. No.: 14/327,319

(22) Filed: Jul. 9, 2014

Related U.S. Application Data
(60) Provisional application No. 61/844,075, filed on Jul. 9, 2013.

(51) Int. Cl. F16B 19/02; F16B 33/00; A63B 21/00

(52) U.S. Cl. CPC F16B 19/02; A63B 21/00047; F16B 33/00; A63B 2225/09
USPC 411/366.1

(57) ABSTRACT

A fastener for a fitness equipment superstructure includes a stud member and a peg member, both of which include a head and a body. The body is sized to be received in holes on uprights of the superstructure to attach one or more accessories thereto. The head is significantly larger in diameter than the body, but thin with a circular profile and radiused corner. The stud member includes a thread portion which mates into a threaded recess in the body of the peg member, with the heads opposing each other on opposite sides of the upright.

### CROSS-REFERENCE TO RELATED APPLICATION(S)

The present application claims priority from Provisional Application No. 61/844,075, filed Jul. 9, 2013 and entitled “Fastener For Fitness Apparatus”. The contents of U.S. provisional patent application Ser. No. 61/844,075 are hereby incorporated by reference in entirety.

### BACKGROUND OF THE INVENTION

The present invention relates to bolts and similar threaded fasteners, particularly for use in assembled fitness equipment superstructures. Fitness equipment superstructures, also referred to as “rack and rig” systems, are known in the art. These systems are mainly for and used in cross fit gyms, pull up rigs, and other athletic/exercise facilities.

The fitness equipment superstructures normally include several uprights or columns. Generally speaking, each upright is constructed from a steel (or other strong metal) tube, such as a 2×2, 2×3 or 3×3 inch rectangular tube, with a number of holes formed along its length. These tubes typically have about an 8 or 9 foot length, with the tube welded at one of its ends to a flat base plate. The flat base plate typically includes bolt holes for bolting to the floor. The holes along the length of the upright are for attaching cross-member bars running between the uprights, or for attaching J-cups and other accessories and hardware.

Common bolts and nuts are used as fasteners for the uprights or J-cups or other accessories, with the bolt running through the rectangular tube. The holes in the uprights are typically fairly large, such as about an inch in diameter. Standard one inch diameter bolts have a hexagonal head which is within the range of 0.5-0.7 inches long, with a distance between opposing flats of about 1½ inches. The length of the bolts (extending from and not including the head) is typically 2½ to 4 inches, to match with the size of the rectangular tube with sufficient threads extending through the tube for attachment of a nut on the other end. The nut used on the opposing end of the bolt is typically a hexagonal nut sized similarly to the bolt head, such as with a length within the range of 0.5-0.8 inches and a distance between opposing flats of about 1½ inches. Such sizes of standard bolts and nuts are useful to support the strains and stresses which will be placed on the rack, such as holding hundreds of pounds of weights or other exercise equipment or withstanding the weight/momentum of an athlete during training.

In years of use in fitness equipment superstructures, the nuts and bolts which are widely used have several drawbacks, which are often not appreciated by users until it is too late (and, to Applicant's knowledge, have not been previously appreciated by fitness equipment superstructure designers). While standard bolts of this size have fairly coarse threads (such as 8 threads per inch of length), the forces placed on the threads during use, and particular impact forces on the threads, can cause the threads to deform. Deformed threads can make it impossible to fully tighten a nut, or if the deformation exists on the end of the threads while the nut is further tightened on, can make it impossible to remove the nut. The corners of the bolt heads and nuts, extending a significant distance away from the upright, can cause injury to the athlete during inadvertent contact. The coarse threads of the bolt can also cause injury to the athlete during any inadvertent contact. Better solutions for attaching cross-member bars, J-cups and other accessories and hardware to the uprights of fitness equipment superstructures are needed.

### BRIEF SUMMARY OF THE INVENTION

The present invention is a fastener for a fitness equipment superstructure, and a fitness equipment superstructure which uses the fastener such as in attaching one or more accessories to uprights of the superstructure. The fastener includes a stud member and a peg member, both of which include a head and a body. The body is sized to be received in holes on the uprights of the superstructure. The head is significantly larger in diameter but thinner, so as to fit closely to the upright without having any sharp corners. The stud member includes a thread portion which mates into a threaded recess in the body of the peg member, with the heads opposing each other on opposite sides of the upright. The fastener is less likely to be damaged than prior art bolts/nuts, avoids safety issues created by prior art bolt/nuts, and provides a more robust attachment than prior art bolts/nuts.

### BRIEF DESCRIPTION OF THE DRAWINGS

FIG. 1 is a perspective view of a fitness equipment superstructure in accordance with the present invention.

FIG. 2 is a perspective view of one of the fasteners of the fitness equipment superstructure of FIG. 1 in a detached state.

FIG. 3 is a side view of the fastener of FIG. 2 in a fully tightened state.

FIG. 4 is a cross-sectional side view of the fastener of FIGS. 2 and 3 shown tightened to hold an accessory to one of the uprights as depicted in FIG. 1.

While the above-identified drawing figures set forth a preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

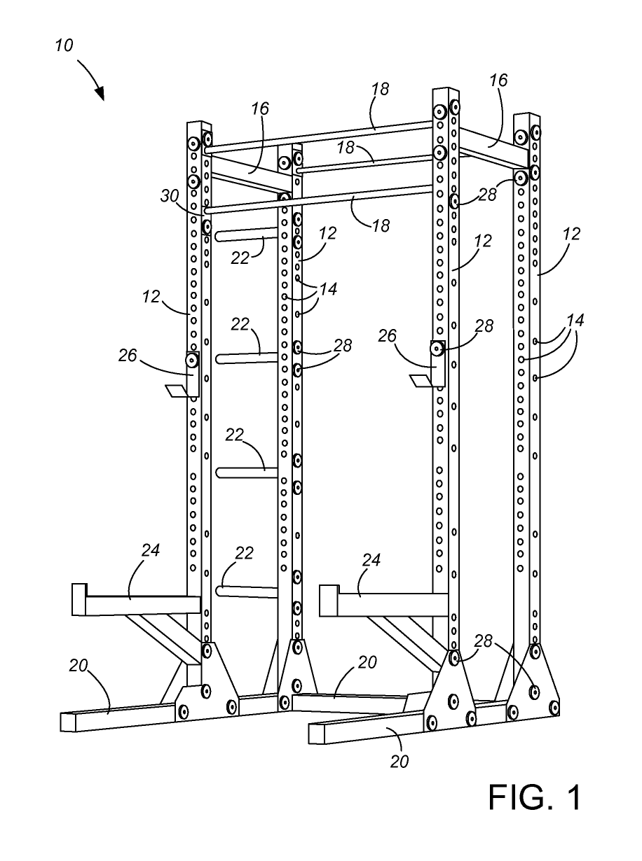

As shown in FIG. 1, a fitness equipment superstructure 10 has, in this example, four columns or uprights 12. In this preferred embodiment, each of the uprights 12 is formed from a 3×3 inch metal tube. The preferred metal tubes are about 8 or 9 feet long, formed from rectangular steel tubing with a wall thickness of about 0.13 inches. Each upright 12 has a series of holes 14 running along its height, which can be used to fasten supports and accessories to the uprights 12. The preferred holes 14 are about 1.06 inches in diameter, spaced at about 2 inch and about 6 inch intervals as desired for mounting hardware to the fitness equipment superstructure 10. If desired, numbering or lettering or a ruler-type scale can be placed on the uprights 12 so users can more readily determine which hole 14 is which and find it easier to return the superstructure 10 to a particular configuration.

In this example, the uprights 12 are attached together at their tops with two rectangular cross-bars 16 running from front to back, as well as three smaller circular cross-bars 18 running from side to side, two in front and one in back. The circular cross-bars 18 can be used, for instance, for pull-ups or similar exercises. The bases of the uprights 12 are secured together with floor beams 20. One of the rear uprights 12 is shown with a series of four weight pegs 22 attached. The weight pegs 22 can be used to hold weightlifting plate freeweights (not shown) as known in the art. Bench or seat supports 24 are attached extending forward from each of the front uprights 12. J-cups 26, which can be used to support a weightlifting bar (not shown), are attached facing forward from each of the front uprights 12. It can readily be understood that a wide variety of different configurations of fitness equipment superstructure set-ups can be achieved with these and similar uprights and accessories, including many configurations which use more than four uprights.

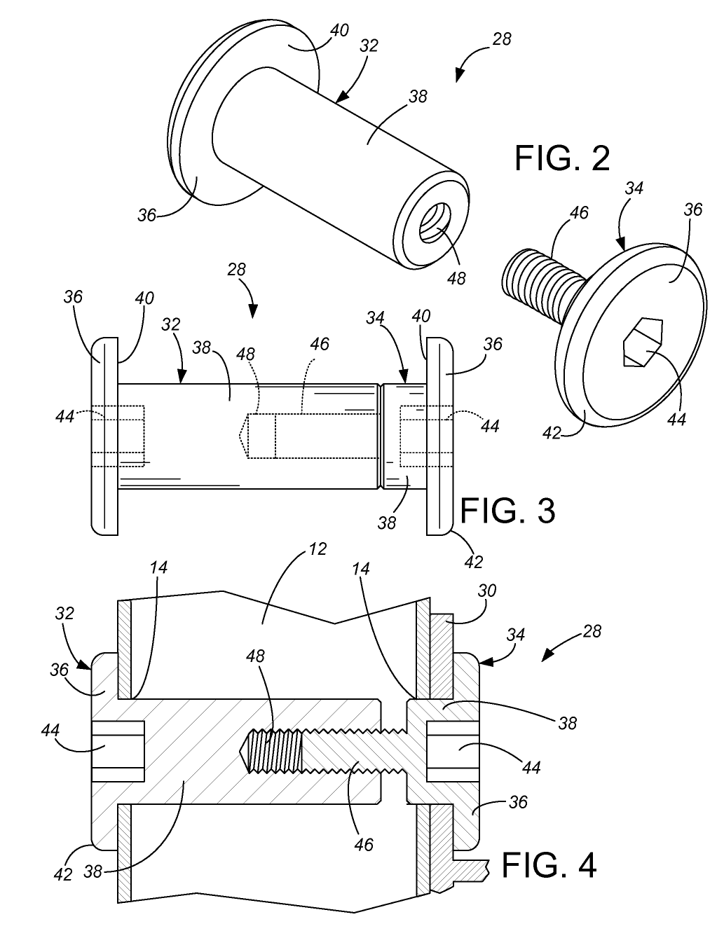

In this preferred embodiment, each of the attachments to the uprights 12 are achieved with one or more fasteners 28, with the preferred fastener 28 shown in more detail in FIGS. 2-4. Each of the accessories 16, 18, 22, 26 includes a plate 30 which is pressed against and attached to the uprights 12 with at least one fastener 28. The fastener 28 includes a female threaded peg member 32 which mates with a male threaded stud member 34.

Both the peg member 32 and the stud member 34 have a head 36 projecting from a body 38. In the preferred embodiment, the head 36 of the peg member 32 is shaped identically to the head 36 of the stud member 34. The head 36 provides a flat shoulder 40 which needs to have enough surface area to transfer the tensile force of the fastener 28 into compression on the sidewalls of the upright 12. The surface area of the flat shoulder 40 in contact with the sidewalls of the upright 12 preferably exceeds the area of the holes 14. In the preferred embodiment for use with 1.06 diameter inch holes 14 in the uprights 12, the head 36 has an outer diameter of 1.88 inches, providing nearly 1.9 square inches of surface contact between the shoulder 40 and the sidewalls of the uprights 12. At the same time, the shoulder 40 should be small enough that the head 36 is well spaced inwardly from the edges of the upright 12. With a 3×3 upright 12, the head 36 has clearance on each side of about a half an inch from the edges of the upright 12. The same head 36 can be used with 2×3 and 2×2 uprights, but within minimal clearance on each side when used on an upright that is only 2 inches wide. The head 36 needs to be thick enough to withstand the tightening force without bending, but otherwise is preferably as thin as possible. This will typically require the head 36 to be at least as thick as the walls of the tubing of the uprights 12, but about equal to or less than twice as thick as the walls of the tubing of the uprights 12. In the preferred embodiment, the head 36 is about 0.25 inches thick, which is 50% or less of the thickness of the head of traditional bolts/nuts the fastener 28 replaces. The head 36 should provide as few sharp corners as possible. In the preferred embodiment, this is achieved by having the head 36 be circular, with a generously radiused corner 42 (such as a radius of half of the thickness of the head 36).

By being thin, without any sharp corners, there is significantly less chance that the head 36 will snag on the user's body or clothes, and significantly less chance of the head 36 causing inadvertent contact or injury with the user while exercising. The surface area of the head 36 provides a location to print promotional information, such as the name of the manufacturer into the head 36 in text with about 0.06 inch depth embossed therein.

With the head 36 not having the flats of the traditional bolt/nut, a mechanism is needed to rotationally torque the stud member 34 and the peg member 32. In the preferred embodiment, this is provided by an allen wrench recess 44, with the preferred recess 44 being 0.45 inches deep and mating with a 0.5 inch hex drive (not shown). The stud member 34 has a thread portion 46 which extends for a threaded distance long enough to join with the peg member 32 with several turns of interlocking thread, both when used on an upright 12 by itself (i.e., when the shoulders 40 are 3 inches apart, such as when securing something inside the upright 12) and when used in attaching a plate 30 to an upright 12. The shoulder 40 of the peg member 32 is thus spaced from the shoulder 40 of the stud member 34 by a distance of two (when sized for 2×2 or 2×3 inch uprights 12) to four inches. The preferred thread portion 46 is 1 inch long and ½ inch in diameter, threaded with size 13 UNC threads. The ½ inch diameter of the thread portion 46 and the size 13 UNC threads have been found sufficient to withstand the tensile forces placed on the fastener 28 during normal use. Preferably a non-permanent thread locker compound (not shown) is applied over about half of the length of the thread portion 46.

The thread portion 46 projects from a body 38. The body 38 needs to be small enough to be received in the holes 14 of the upright 12. The body 38 extends with a length that exceeds twice the wall thickness of the tubes of the uprights 12. In the preferred embodiment, the body 38 extends for about 0.45 inches, and is cylindrical with an outer diameter of 1 inch. The body 38 fulfills several functions. First, the body 38 receives the alien wrench recess 44 and has sufficient thickness beyond the alien wrench recess 44 to transfer torque from the head 36 to the thread portion 46. Second, the body 38 mates a significant distance into the hole 14 which receives it, to withstand shear forces of whatever it is attaching to the upright 12. This is best seen in FIG. 4, wherein the body 38 extends both through the accessory plate 30 and fully into the hole 14 in the upright 12. In this way, the shear forces between the accessory plate 30 and the upright 12 are withstood by the body 38 rather than by the thread portion 46, meaning that the thread portion 46 is much less likely to be damaged during use than the prior art bolt (such as when the user drops a weight bar onto the J-cups 26).

The peg member 32 also has a body 38 which in the preferred embodiment is cylindrical. The preferred body 38 of the peg member 32 extends for about 2½ inches beyond the shoulder 40, meaning that if fully tightened the two bodies 38 abut each other when the shoulders 40 are about 2.95 inches apart, which permits full tightening onto the 3×3 inch upright 12. Whenever attaching an accessory plate 30 to the outside of the upright 12, the bodies 38 will be spaced apart by at least the thickness of the accessory plate 30. The body 38 of the peg member 32 includes a female threaded recess 48 which mates with the thread portion 46 of the stud member 34. In the preferred embodiment, the female threaded recess 48 is about 1.25 inches deep, with ½ inch diameter size 13 UNC threads (0.42 inch inner diameter).

Both the peg member 32 and the stud member 34 are formed of a strong metal. In the preferred embodiment, both are formed of ASTM A325 steel, with at least a 120 KSI tensile strength and a 92 KSI yield strength. A finish may be applied, such as of polished black zinc.

The fasteners 28 of the present invention provide attachments that are more robust and less likely to damage or strip than prior art bolts and nuts. The fitness equipment superstructure 10 using the fasteners 28 provides more safety to users, while at the same time offering a cleaner looking appearance.

Although the present invention has been described with reference to preferred embodiments, workers skilled in the art will recognize that changes may be made in form and detail without departing from the spirit and scope of the invention.

What is claimed is:

1. A fitness equipment superstructure comprising:
a plurality of uprights extending generally vertically, each of the uprights formed of tubing and having a plurality of holes spaced at different heights,
at least one accessory attached to an upright with a fastener, the fastener comprising:
a stud member comprising:
a head being larger than the holes of the uprights, the head providing a shoulder;
a body extending from the head and sized to be received in the holes of the uprights; and
a thread portion extending from the body; and
a peg member comprising:
a head being larger than the holes of the uprights, the head providing a shoulder;
a body extending from the head and sized to be received in the holes of the uprights; and
a female threaded recess in the body sized to rotationally receive the thread portion of the stud member, such that the shoulder of the peg member is spaced from the shoulder of the stud member on opposing sides of the upright.

2. The fitness equipment superstructure of claim 1, wherein the head of the stud member and the head of the peg member both comprise an allen wrench recess.

3. The fitness equipment superstructure of claim 2, wherein the head has a thickness that is less than a depth of the allen wrench recess.

4. The fitness equipment superstructure of claim 1, wherein the uprights are formed of rectangular tubing with a wall thickness, and wherein the bodies are cylindrical each with a length that exceeds twice the wall thickness.

5. The fitness equipment superstructure of claim 4, wherein the bodies have a diameter of about 1 inch.

6. The fitness equipment superstructure of claim 5, wherein the thread portion has a diameter of about ½ inch.

7. The fitness equipment superstructure of claim 6, wherein the heads have a thickness which is about equal to or less than twice the wall thickness of the rectangular tubing of the uprights.

8. The fitness equipment superstructure of claim 7, wherein the shoulder has a surface area in contact with the walls of the upright which exceeds the area of each hole.

9. The fitness equipment superstructure of claim 1, wherein the accessory is a J-cup.

10. The fitness equipment superstructure of claim 1, wherein the accessory is a cross-member running between uprights, attached with at least one fastener to each of the uprights.

11. The fitness equipment superstructure of claim 1, wherein the accessory is a weight peg attached to one of the uprights with two fasteners.

12. The fitness equipment superstructure of claim 1, wherein the heads are circular with a radiused corner.

13. A fastener for a fitness equipment superstructure comprising:
a stud member comprising:
a circular head which is larger than one inch in diameter, the head providing a shoulder;
a body extending from the head, the body being cylindrical with a diameter of about 1 inch; and
a thread portion extending from the body; and
a peg member comprising:
a circular head which is larger than one inch in diameter, the head providing a shoulder;
a body extending from the head, the body being cylindrical with a diameter of about 1 inch; and
a female threaded recess in the body sized to rotationally receive the thread portion of the stud member, such that the shoulder of the peg member is spaced from the shoulder of the stud member by a distance of 2 to 4 inches.

14. The fastener of claim 13, wherein each shoulder has a surface area which exceeds a cross-sectional area of the body.

15. The fastener of claim 14, wherein each head is circular with a radiused corner.

16. The fastener of claim 15, wherein the thread portion has a diameter of about ½ inch.

17. The fastener of claim 16, wherein the head of the stud member and the head of the peg member both comprise an allen wrench recess.

18. The fastener of claim 17, wherein the head has a thickness that is less than a depth of the allen wrench recess.
